(19) United States
(12) Patent Application Publication
(10) Pub. No.: US 2008/0290165 A1
(43) Pub. Date: Nov. 27, 2008

(54) Data Carrier with a Radio Frequency Interface

(75) Inventors: Roland Brandl, Eggersdorf bei Graz (AT); Robert Spindler, Graz (AT); Ewald Bergler, Weiz (AT)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/065,016

(22) PCT Filed: Aug. 24, 2006
(86) PCT No.: PCT/IB06/52942

§ 371 Date: Feb. 27, 2008

(30) Foreign Application Priority Data
Sep. 2, 2005 (EP) 05108037.2

(51) Int. Cl. G06K 19/07

(52) U.S. Cl. 235/441

(57) ABSTRACT

A circuit for a contact-free data carrier comprises a first circuit point and a second circuit point for connection to transmission means of the data carrier; and supply voltage generating means, which are connected to the first connection circuit point and comprise a supply voltage circuit point and a reference potential circuit point and are designed to generate, based on the received carrier signal, a first supply voltage that can be tapped at the supply voltage circuit point against the reference potential circuit point; and direct current decoupling means, which are connected between the second circuit point and the reference potential circuit point and are designed to inhibit a direct current flow between the second circuit point and the reference potential circuit point; and current conducting means that are connected between the second circuit point and the reference potential circuit point, wherein the current conducting means are designed for the unidirectional conduction of current from the reference potential circuit point to the second circuit point.

### FIELD OF THE INVENTION

The invention relates to a circuit for a data carrier.

The invention further relates to a data carrier with a circuit according to the preceding paragraph.

### BACKGROUND OF THE INVENTION

Recent developments in industry have shown that Radio Frequency Identification Systems (RFID-systems) are becoming an integrated part of logistics and transportation applications. On one hand such RFID-systems typically comprise at least one data carrier, which data carrier comprises an integrated circuit and transmission means that are connected to the integrated circuit. On the other hand such RFID-systems comprise a read/write station that provides a Radio Frequency (RF) carrier signal for the purpose of powering the integrated circuit of the data carrier and for exchanging data with said integrated data carrier using the RF carrier signal in a contact-free manner. Due to increasing demand for long distance RFID-systems, the domain of Ultra High Frequency (UHF) RFID-systems that operate up to the GHz frequency range is recently becoming very important for such logistics and transportation applications. Such (UHF) RFID-systems are typically designed to operate according to the international standard ISO18000-6.

FIG. 1 shows a prior art RFID data carrier 1 that comprises the above transmission means 2 and the integrated circuit 3. The integrated circuit 3 shows a first connection pad 4 that forms a first connection circuit point and a second connection pad 5 that forms a second connection circuit point. A loop antenna that is basically designed as a dipole, in which the outer ends of the dipole are short-circuited with each other, realizes the transmission means 2. However other designs of such loop antennas are also known to those skilled in the art. Inner ends of the dipole are connected to the first connection pad 4 and the second connection pad 5 respectively. The known circuit 3 further comprises supply voltage generating means 6, which are designed to generate, based on a received carrier signal CS, a supply voltage VDD and to supply said supply voltage VDD for the circuit 3 at a supply voltage circuit point 7. The supply voltage VDD can be tapped from said supply voltage point 7 against a reference voltage circuit point GND. The circuit 3 further comprises a capacitor 8 that is connected between the second connection pad 5 and the reference potential circuit point GND. The herein described interface for the loop antenna is well known to those skilled in the art as an unbalanced input for connecting the loop antenna, because the capacitor 8 acts as an alternate current (AC) short-circuit against the reference potential for one of the inner ends of the dipole that is connected to the second connection pad 5. The prior art data carrier 1 also comprises signal-processing means 9, which are schematically indicated. The signal processing means 9 typically comprise (not shown in FIG. 1) a microprocessor or equivalent logic circuitry to perform logic and/or arithmetic operations on data that are either stored in an internal memory or received or are to be transmitted using the carrier signal CS, a modulation stage and a demodulation stage. Both, the modulation stage and the demodulation stage, are connected to the first connection pad 4 and to the e.g. microprocessor and serve to receive and transmit data in a well-known manner.

The prior art data carrier has the problem that it always requires a radio frequency (RF) signal for proper operation, which in particular requires the use of relatively expensive test equipment to test the circuit 3.

### OBJECT AND SUMMARY OF THE INVENTION

It is an object of the invention to provide a circuit of the type mentioned in the first paragraph and a data carrier of the type mentioned in the second paragraph, which obviate the drawbacks described above.

To achieve the object described above, characteristic features according to the invention are provided with a circuit according to the invention, so that a circuit according to the invention can be characterized as follows: Circuit for a data carrier, which data carrier comprises transmission means that are designed to receive a carrier signal from a read/write station in a contact-free manner and to be connected to the circuit to feed the circuit with the received carrier signal, in which the circuit comprises a first circuit point and a second circuit point, which first circuit point and second circuit point are designed to be connected to said transmission means of the data carrier; and supply voltage generating means, which supply voltage generating means are designed and arranged to be in contact with the first circuit point and the second circuit point to receive said carrier signal and which supply voltage generating means comprise a supply voltage circuit point and a reference potential circuit point and which supply voltage generating means are designed to generate, based on the received carrier signal, a first supply voltage that can be tapped at the supply voltage circuit point against the reference potential circuit point; and a direct current decoupling means, which direct coupling decoupling means are connected between at least one of the circuit points that are designed to be connected to said transmission means and the supply voltage generating means and which direct decoupling means are designed to inhibit a direct current flow between the respective circuit point that is designed to be connected to the transmission means and the supply voltage generating means; and current conducting means that are connected in parallel connection to the direct current decoupling means, in which the current conducting means are designed for the unidirectional conduction of current from the first circuit point through the supply voltage generating means to the second circuit point.

To achieve the object described above, a data carrier according to the invention comprises a circuit according to the invention.

The provision of the characteristic features according to the invention creates the advantage that no radio frequency signal-generating device is required to perform a proper operation of the circuit of the data carrier. In comparison to a radio frequency signal based testing equipment this invention allows the use of significantly cheaper and simple test equipment for testing purposes, while at the same time no additional pads or connectors are required to perform chip testing operations and to connect the transmission means. In addition the radio frequency (RF) operation of the circuit is also not affected by the design according to the invention, because the measures according to the invention provide proper operation for radio frequency (alternate current) signals as well as for direct current signals that are fed into the circuit via the two connection pads of the circuit, which connection pads are typically used to be connected to the transmission means.

Some solutions according to the invention offer the advantage that a supply voltage for supplying electrical power to the parts of the circuit that have to be powered can be produced in a manner based on both an RF signal and a direct current signal. As a further advantage, it is possible to have the value of the second supply voltage, which is established via the direct current input signal, as being different from the first supply voltage that is established based on the RF signal.

Other solutions according to the invention offer the advantage that the original design of the supply voltage generating means, which design was based on the concept of operating the circuit by RF signals only, does not have to be changed significantly in order to provide the second supply voltage. In a particular solution only one part of the supply voltage generating means has to be bypassed by relatively simple bypassing means.

Other solutions according to the invention offer the advantage that data can also be provided to the circuit and such data can be processed, as they would have been if provided by RF signals. It has proved to be of particular advantage if the structure of the direct current signal corresponds to the envelope of the modulated carrier signal that would be used for providing data if the circuit were operated by RF signals. This provides the advantage that data can be relatively simply communicated to the circuit, whilst avoiding the necessity of any carrier signal or modulation of such a carrier signal.

Other solutions according to the invention offer the advantage that instead of an input stage, which is basically designed for RF signals, a part of the supply voltage generating means can be utilized without any modifications of the original design of the RF signal-based circuit. The only measure to be taken into account is a relatively simple coupling means that guarantees that the supply voltage generating means and the demodulation means do not interfere each other with RF signal-based operation; while at the same time a DC signal based operation is enabled.

These and other aspects of the invention are apparent from and will be elucidated with reference to the embodiments described below.

### BRIEF DESCRIPTION OF THE DRAWINGS

The invention will be described in greater detail below, by way of a non-limiting example, with reference to the embodiments shown in the drawings.

FIG. 1 shows schematically in the form of a block diagram a data carrier comprising a circuit according to prior art.

FIG. 2 shows in the same way as FIG. 1 a data carrier according to a first embodiment of the invention.

FIG. 3 shows a modulated carrier signal that can be used for communication with a data carrier according to FIG. 1 or according to FIG. 2.

FIG. 4 shows a direct current signal that can be used for communication with a data carrier according to FIG. 2.

FIG. 5 shows in the same way as FIG. 1 a data carrier according to a second embodiment of the invention.

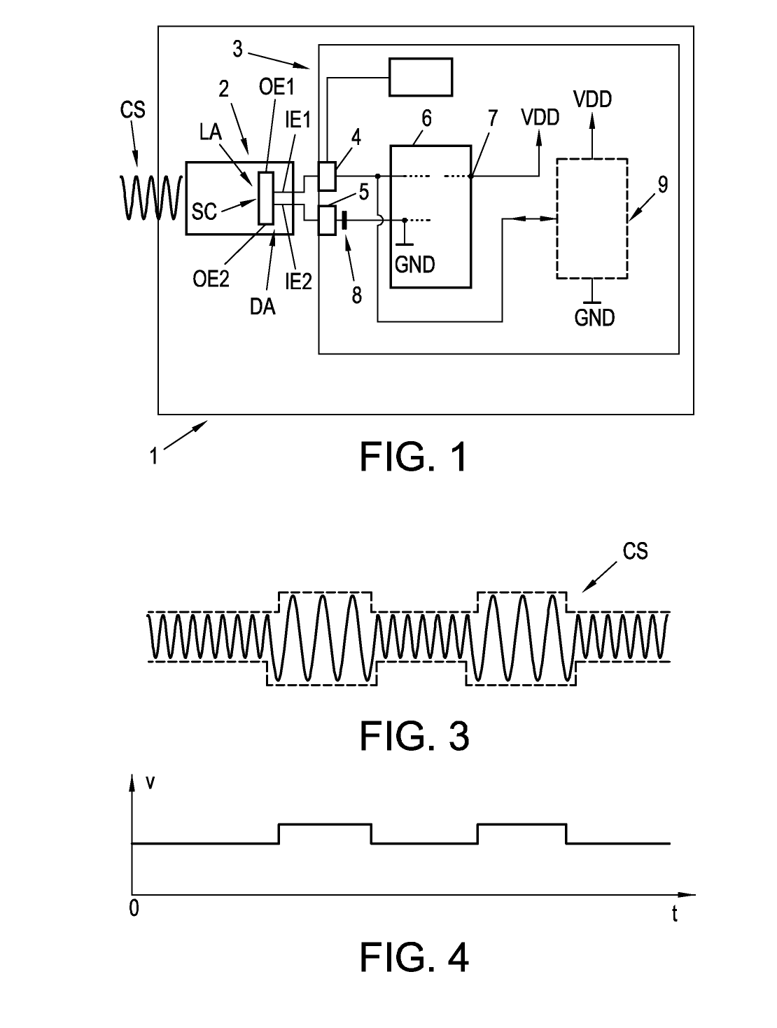

### DESCRIPTION OF EMBODIMENTS

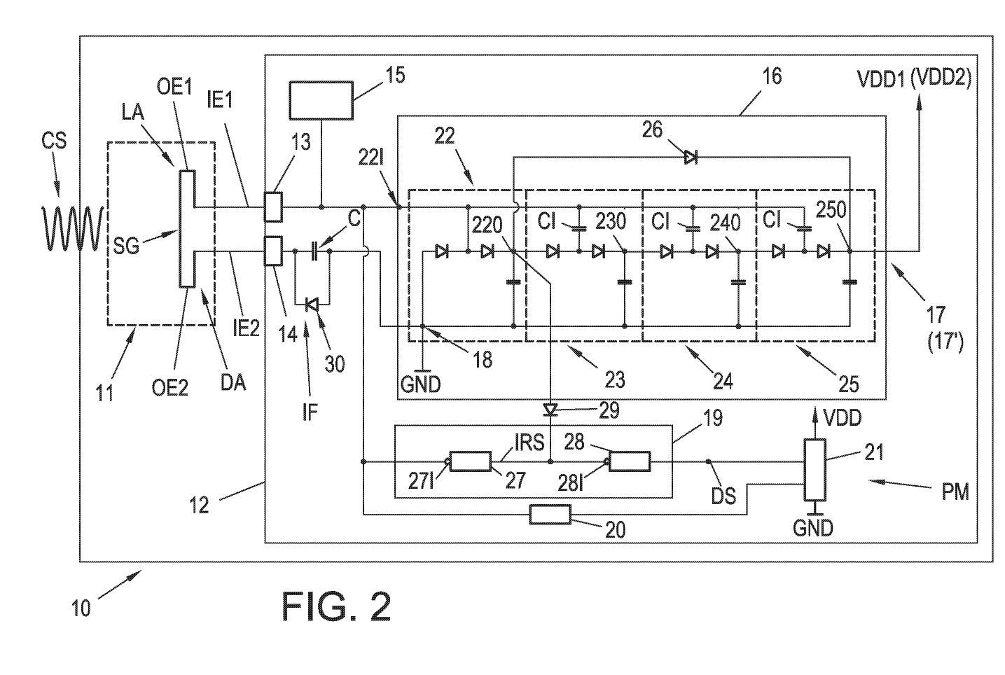

FIG. 2 shows a data carrier 10 that is designed to be compliant with the international standard ISO18000-6. The data carrier 10 comprises transmission means 11 and an integrated circuit 12. The integrated circuit 12 comprises a first connection pad 13 that forms a first connection circuit point and a second connection pad 14 that forms a second connection circuit point.

The transmission means 11 are designed to receive in a contact-free manner a carrier signal CS from a read/write station (not shown in FIG. 3) and to be electrically connected to the integrated circuit 12. A loop antenna LA that is basically designed as dipole antenna DA, in which the outer ends OE1 and OE2 of the dipole are short-circuited SC with each other, realizes the transmission means 11. A first inner end IE1 of the dipole antenna DA is connected to the first connection pad 4 and a second inner end IE2 of the dipole antenna DA is connected to the second connection pad 5.

The circuit 12 comprises an electrostatic discharge stage 15 that is connected to the first connection pad 13 and the second connection pad 14. The electrostatic discharge stage 15 is designed to protect the circuit 12 against electrostatic charge caused damage.

The circuit 12 further comprises supply voltage generating means 16, which are designed for generating, based on a received radio frequency (RF) carrier signal CS, a first supply voltage VDD1 against a reference potential GND and to supply said first supply voltage VDD1 for the circuit 12 at a supply voltage circuit point 17. The first supply voltage VDD1 can be tapped during operation from said supply voltage point 17 against a reference voltage circuit point 18. The circuit 12 further comprises a capacitor C that is connected between the second connection pad 14 and the reference potential circuit point 18.

The herein described interface IF for the loop antenna is well known to those skilled in the art as an unbalanced input for the loop antenna, because the capacitor C acts as an alternate current (AC) short-circuit against the reference potential for the second inner end IE2 of the dipole that is connected to the second connection pad 14.

The circuit 12 further comprises demodulation means 19, responding mean 20 and a processing stage 21. The demodulation means 19, the responding means 20 and the processing stage 21 realize processing means PM, which are designed to process data that are either incoming data, which can be received in a contact-free communication, or data that are solely intended to be internally processed or data that are outgoing data, which are intended to be transmitted back to the read/write station.

The supply voltage generating means 16 are realized as a multi-stage charge pump comprising a first charge pump stage 22, a second charge pump stage 23, a third charge pump stage 24 and a fourth charge pump stage 25. The first charge pump stage 22 comprises a first input 221 that is connected to the first connection pad 13. The first charge pump stage 22 is also connected to the reference potential circuit point 18 as shown in FIG. 2. The first charge pump further comprises a first output 220. Each of the remaining charge pumps 23, 24 and 25 comprise an input and an output 230, 240 and 250 as described below. The charge pump stages 22, 23, 24 and 25 are connected in series to each other. In this series connection the first output 220 of the first charge pump stage 22 forms a second input of the second charge pump 23, the second output 230 of the second charge pump stage 23 forms a third input of the third charge pump stage 24, the third output 240 of the third charge pump stage 24 forms a fourth input of the fourth charge pump 25, which fourth charge pump stage 25 comprises the fourth output 250. The fourth output 250 realizes the supply voltage circuit point 17. The first charge pump stage 22 realizes a first charge pump unit having as an output the output 220 of the first charge pump stage 22. The charge pump stages 23, 24 and 25 realize a second charge pump unit having as an output the output 250 of the fourth charge pump stage 25. In the present case the first charge pump unit comprises only the charge pump stage 25 and the second charge pump unit comprises three (3) charge pump stages 23, 24 and 25.

The supply voltage generating means 16 further comprises bypass means 26 that are connected on the one hand to the first output 220 of said first charge pump stage 22 and on the other hand to the fourth output 250 of the fourth charge pump stage 25. In the present case the bypass means are realized by means of a diode that is connected at its anode to the first output 220 and at its cathode to the fourth output 250. Consequently the bypass means are designed for the unidirectional conduction of current in direction from the first output 220 to the fourth output 250. In the present case the bypassing means 26 bridge the three charge pump stages 23, 24 and 25.

The demodulation means 19 comprise an input stage 27 and a demodulation stage 28. The input stage 27 is connected at its input side 271 to the first connection pad 13 and is realized as the fifth charge pump, which is used to establish a voltage that shows a value that is appropriate to be demodulated if data is received by means of the RF carrier signal CS. By means of utilizing the fifth charge pump in order to establish said voltage, the input stage 27 is designed to provide an information representation signal IRS, which represents information that is provided by a modulation of said carrier signal CS with data. The information representation signal IRS represents the envelope curve of the modulated carrier signal CS. The carrier signal CS having said envelope (dashed line) is shown in FIG. 2. The demodulation stage 28 is designed to receive the information representation signal IRS at its input 28I and to demodulate the information representation signal IRS and to release a data signal DS to the processing stage 21, which data signal DS comprising data that represent the information that is provided by a modulation of said carrier signal CS.

The circuit 12 further comprises coupling means 29 that are connected on one hand to the first output 220 of the first charge pump stage 22 and on the other hand to the input DSI of the demodulation stage 28. In the present case the coupling means are realized by means of a diode and the anode of the diode is connected to the first output 220 and the cathode of the diode is connected to the input DSI of the demodulation stage 28.

According to a further embodiment the first charge pump unit may comprise the two (2) charge pump stages 22 and 23, while the second charge pump stage may comprise the two (2) charge pump stages 24 and 25 and the bypassing means 26 bridge the two charge pump stages 24 and 25, while the coupling means 29 couple the output 230 of the second charge pump stage 23 with the input 28I of the demodulation stage 28. According to a further embodiment the first charge pump unit may comprise the three (3) charge pump stages 22 and 23 and 24 while the second charge pump unit may comprise the two charge pump stages 25 and the bypassing means 26 bridge the charge pump stages 25 and the coupling means couple the output 240 of the third charge pump stage 24 with the input 28I of the demodulation stage 28. However it has proved to be of advantage if the first charge pump unit comprises as few charge pump stages 22 . . . 24 as possible in order to minimize the voltage loss (drop) over this charge pump stages 22 . . . 24.

The response means 20 are connected at their output to the first connection pad 13 and at their input to the processing stage 21. The response means 20 are designed to receive response data RD from the processing stage 21 and to change, depending on the response data RD, the impedance of the input of the circuit 12 for the incoming carrier signal CS, such that a back scatter signal is produced that can be detected on the side of the read/write station.

The circuit 12 further comprises current conducting means 30 that are connected between the second connection pad 14 and the reference potential circuit point 18, in which the current conducting means 30 are designed for the unidirectional conduction of current from the reference potential circuit point 18 to the second connection pad 14. In the present case the current conducting means 30 are realized by a diode, which diode is connected at its anode to the reference potential circuit point 18 and at its cathode to the second connection pad 14.

Providing by the above-described measures the circuit 12 allows a direct current signal as shown in FIG. 4, which structurally shows the envelope shape of the carrier signal according to FIG. 3, to be fed into the circuit 12 via the first connection pad 13 and the second connection pad 14 in order to operate the circuit 12 as it would be operated if the RF carrier signal CS were received via the transmission means 11 of the data carrier 10. In operation the current conducting means 30 allow a direct current flow between the first connection pad 13 and the second connection pad 14 by means of bypassing the capacitor C, which capacitor C basically does not allow any direct current to pass. However, the radio frequency operation of the circuit is not interfered with as the diode is short-circuited for high frequencies by the capacitor C. In this context the operation of the data carrier 10, in which the circuit 12 receives the RF carrier signal CS and utilizes it to be supplied with power, is called the “RF operation”. By providing the bypass means 26 to the supply voltage generating means 16 the supply voltage generating means 16 are designed to receive said direct current signal and to provide, based on said direct current signal, a second supply voltage VDD2 that can be tapped at a third circuit point 17′ against the reference potential circuit point 18.

In some embodiments it might be useful to have the value of the second supply voltage VDD2 to be different from the value of the first supply voltage VDD1 and to have the second supply voltage VDD2 available at the third circuit point 17′ (not shown in the Figures), which is different from the supply voltage circuit point 17. However, according to the embodiment shown in FIG. 2, the third circuit point 17′ is identical to the supply voltage circuit point 17 and the value of the second supply voltage VDD2 is equal to the value of the first supply voltage VDD1.

By coupling, using the coupling means 29, the supply voltage generating means 16 to the demodulating means 19, the direct current signal, which is available at the first output 220 of the first charge pump stage 22, can be used in the demodulation stage 28 to produce the data signal DS for the processing stage 21. Therefore, the direct current signal preferably comprises sequences of direct current levels in consecutive order, as the modulated radio frequency carrier signal CS would show in the form of its envelope. The direct current signal provided to the demodulation stage 28 is under these conditions the substitute of the information representation signal IRS that would be provided from the input stage 27 of the demodulation means 19 in the event of a radio frequency signal operation of the circuit 12. Consequently, during an “envelope direct current signal operation” of the circuit 12 the input stage 27 is realized by the first charge pump stage 22 of the supply voltage generating means 16.

In the event of such an envelope direct current signal operation the input stage 27 of the demodulation means 19 block the direct current signal and any interference with the input stage 27 is avoided. On the other hand during radio frequency operation the unidirectional current conducting behavior of the coupling means 29 provides for interference-free operation of the demodulation means 19 independently from the supply voltage generating means 16.

In order to guarantee a relatively loss-freepassage of the direct current signal through the supply voltage generating means 16, the first charge pump stage 22 shows a design that is slightly different from the other charge pump stages 23, 24 and 25. In contrast to the charge pump stages 23, 24 and 25 the input capacitor CI shown in the charge pump stages 23, 24 and 25 has been removed from the first charge pump stage 22 and the first charge pump stage 22 comprises only the rectifier structure realized by three diodes, in which a capacitor is connected in parallel with the rectifier structure to the first output 220, as shown in FIG. 2.

As common known the processing stage 21 must be powered by a processing stage supply voltage VDD. In the present case the processing stage supply voltage VDD is different from the first supply voltage VDD1. In practice further supply voltage generating means are required and provided to establish the processing stage supply voltage VDD based on the first supply voltage VDD1. These further supply voltage generating means are not shown in FIG. 2. However, in a further embodiment the processing stage 21 can also be designed to operate with the first supply voltage VDD1. The same statement is valid for the utilization of the second supply voltage VDD2.

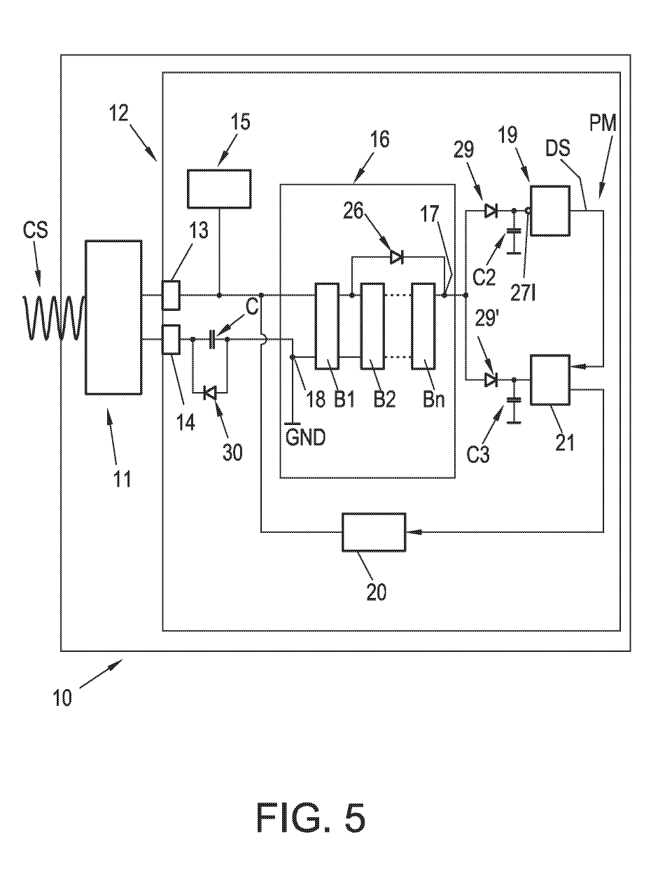

In a second embodiment of the invention as shown in FIG. 5 the supply voltage generating means 16 also comprise a plurality of stages to generate the desired supply voltage VDD1, in which blocks B1, B2 to Bn indicate the stages. The bypass means 26 are also shown.

In contrast to FIG. 2 the coupling means 29 couple the supply voltage generating means 16 at the supply voltage circuit point 17 to the demodulation means 19. A second capacitor C2 is connected between the input side 271 of the demodulation means 19 and the reference potential GND. A further coupling means 29′ couples the supply voltage generating means 16 at the supply voltage circuit point 17 to the processing stage 21. The further coupling means 29′ provide the supply voltage VDD1 or VDD2, respectively, to the processing stage 21. Connected between the further coupling means 29′ and the processing means 21 on one side and the reference potential GND on the other side is a third capacitor C3. The value of the third capacitor C3 is higher than the value of the second capacitor C2 because the second capacitor C2 buffers the demodulation path and the third capacitor buffers the supply voltage path. The advantages as disclosed for the first embodiments also apply to the second embodiment of the invention.

Although in the described embodiments of the invention the direct current conducting means have been described as a general diode it can be mentioned that a particular diode, like a “Schottky” diode or a transistor, which is operated as a diode, can also be used to realize the direct current conducting means. Other electronic components having the appropriate properties are considered as being comprised for those skilled in the art who know the teaching of this invention.

The data carrier and its circuit described throughout this text may also be designed to be compliant with other radio identification system related standards like ISO 18000-3 AAAAA, ISO 18000-4, or may show a generic design in which the problem given by the unbalanced coupling of said transmission means 11 to the circuit 12 needs to be overcome.

It can be mentioned that in a further embodiment the direct coupling decoupling means (C) can also be located between the first circuit point (13) and the input of the supply voltage generating means (16) and that the current conducting means (30) are connected in parallel connection to the direct current decoupling means (C) in order to allow a direct current flow from the first circuit point (13) through the supply voltage generating means (16) to the second circuit point (14).

It can also be mentioned that in a further embodiment more than one antenna is provided and that one common ground pad is used for the purpose of applying the teaching of the present invention.

It finally should be noted that the above embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The words “comprising” and “comprises”, and the like, do not exclude the presence of elements or steps other than those listed in any claim or the specification as a whole. The singular reference of an element does not exclude the plural reference of such elements and vice-versa. In a device claim enumerating several means, several of these means may be embodied by one and the same item of hardware (or software). The mere fact that certain measures are recited in mutually different dependent claims does not indicate that a combination of these measures cannot be used to advantage.

1. Circuit for a data carrier, which data carrier comprises transmission means that are designed for receiving in a contact-less manner a carrier signal from a read/write station and for being connected to the circuit for feeding the circuit with the received carrier signal, wherein the circuit comprises:
a first circuit point and a second circuit point, which first circuit point and second circuit point are designed to be connected with said transmission means of the data carrier; and
supply voltage generating means, which supply voltage generating means are designed and arranged to be in contact with the first circuit point and the second circuit point for receiving said carrier signal and which supply voltage generating means comprise a supply voltage circuit point and a reference potential circuit point and which supply voltage generating means are designed for generating based on the received carrier signal a first supply voltage that is tap-able at the supply voltage circuit point against the reference potential circuit point; and
a direct current decoupling means, which direct coupling decoupling means are connected between at least one of the circuit points that are designed to be connected with said transmission means and the supply voltage generating means and which direct decoupling means are designed to inhibit a direct current flow between the respective circuit point that is designed to be connected with the transmission means and the supply voltage generating means; and
current conducting means that are connected in parallel connection to the direct current decoupling means, wherein the current conducting means are designed for the unidirectional conducting of current from the first circuit point through the supply voltage generating means to the second circuit point.

2. A circuit according to claim 1, wherein the supply voltage generating means are designed to receive a direct current signal that is apply-able between the first circuit point and the second circuit point and for providing based on the direct current signal a second supply voltage that is tap-able at a supply voltage circuit point against the reference potential circuit point.

3. A circuit according to claim 2, wherein the supply voltage generating means are realized by means of a multi-stage charge pump that comprises at least a charge pump unit and at least a second charge pump unit, wherein said first charge pump unit comprises a first output and said second charge pump unit comprises a second output, which second output realizes the supply voltage circuit point, and the supply generating means further comprise bypassing means that are connected between the first output of said first charge pump unit and the second output of said second charge pump unit, wherein the bypassing means are designed for the unidirectional conducting of current in direction from the first output to the second output.

4. A circuit according to claim 2, wherein processing means are provided, which processing means are coupled with the supply voltage circuit point and are designed to be powered either by the aid of the first supply voltage or by the aid of the second supply voltage, and wherein the processing means are designed to receive at least a representation of the direct current signal and to process data represented by the aid of different levels of the direct current signal during individual time durations.

5. A circuit according to claim 3, wherein demodulation means are provided, which demodulation means are designed to demodulate an information representation signal that represents an information that is provided by the aid of the direct current input signal and which demodulation means comprise an input stage and a demodulation stage, wherein the input stage is realized by the aid of said first charge pump unit and the first output of said first charge pump unit is coupled by the aid of coupling means to the demodulation stage.

6. A data carrier, which data carrier comprises transmission means that are designed for receiving in a contact-less manner a carrier signal from a read/write station and for being connected to a circuit for feeding the circuit with the received carrier signal, wherein the circuit is a circuit according to claim 1.
